(19) United States
(12) Patent Application Publication
(10) Pub. No.: US 2025/0344225 A1
(43) Pub. Date: Nov. 6, 2025

(54) START TIME FOR ON-DEMAND SS/PBCH BLOCK TRANSMISSION

(71) Applicant: Samsung Electronics Co., Ltd., Suwon-si (KR)

(72) Inventor: Hongbo Si, Allen, TX (US)

(21) Appl. No.: 19/171,115

(22) Filed: Apr. 4, 2025

Related U.S. Application Data
(60) Provisional application No. 63/641,136, filed on May 1, 2024.
(60) Provisional application No. 63/648,459, filed on May 16, 2024.
(60) Provisional application No. 63/688,613, filed on Aug. 29, 2024.
(60) Provisional application No. 63/710,920, filed on Oct. 23, 2024.

(51) Int. Cl. H04W 72/30; H04W 56/00

(52) U.S. Cl. CPC H04W 72/30; H04W 56/0045

(57) ABSTRACT

Apparatuses and methods related to a start time for an on-demand transmission in a wireless communication system. A method includes receiving a set of higher layer parameters that include a set of configurations for on-demand synchronization signals and physical broadcast channel (SS/PBCH) blocks, receiving a first medium access control (MAC) control element (CE), and identifying, based on the set of configurations, a set of actually transmitted SS/PBCH blocks in a burst. The method further includes identifying a first actually transmitted SS/PBCH block from on the set of actually transmitted SS/PBCH blocks in the burst, identifying, based on the first MAC CE, an indication of an activation of a transmission for the on-demand SS/PBCH blocks, determining, based on the first actually transmitted SS/PBCH block, a first slot corresponding to a beginning of the transmission for the on-demand SS/PBCH blocks, and receiving the on-demand SS/PBCH blocks based on the first slot.

### CROSS-REFERENCE TO RELATED APPLICATIONS AND CLAIM OF PRIORITY

The present application claims priority to:
U.S. Provisional Patent Application No. 63/641,136, filed on May 1, 2024;
U.S. Provisional Patent Application No. 63/648,459, filed on May 16, 2024;
U.S. Provisional Patent Application No. 63/688,613, filed on Aug. 29, 2024; and
U.S. Provisional Patent Application No. 63/710,920, filed on Oct. 23, 2024.
   The contents of the above-identified patent documents are incorporated herein by reference.

### TECHNICAL FIELD

The present disclosure relates generally to wireless communication systems and, more specifically, the present disclosure relates to a determination of a start time for an on-demand transmission in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a determination of a start time for an on-demand transmission in a wireless communication system.

In one embodiment, a user equipment (UE) in a wireless communication system is provided. The UE includes a transceiver configured to receive a set of higher layer parameters and receive a first medium access control (MAC) control element (CE). The set of higher layer parameters include a set of configurations for on-demand synchronization signals and physical broadcast channel (SS/PBCH) blocks. The UE further includes a processor operably coupled to the transceiver. The processor is configured to identify, based on the set of configurations, a set of actually transmitted SS/PBCH blocks in a burst, identify a first actually transmitted SS/PBCH block from the set of actually transmitted SS/PBCH blocks in the burst, identify, based on the first MAC CE, an indication of an activation of a transmission for the on-demand SS/PBCH blocks, and determine, based on the first actually transmitted SS/PBCH block, a first slot corresponding to a beginning of the transmission for the on-demand SS/PBCH blocks. The transceiver is further configured to receive the on-demand SS/PBCH blocks based on the first slot.

In another embodiment, a base station (BS) in a wireless communication system is provided. The BS includes a processor configured to determine a set of higher layer parameters that include a set of configurations for on-demand SS/PBCH blocks, determine a set of actually transmitted SS/PBCH blocks in a burst in the set of configurations, identify a first actually transmitted SS/PBCH block from on the set of actually transmitted SS/PBCH blocks in the burst, and determine, based on the first actually transmitted SS/PBCH block, a first slot corresponding to a beginning of a transmission for the on-demand SS/PBCH blocks. The BS further includes a transceiver operably coupled to the processor. The transceiver is configured to transmit the set of higher layer parameters, transmit a first MAC-CE, the MAC CE including an indication of an activation of the transmission for the on-demand SS/PBCH blocks, and transmit the on-demand SS/PBCH blocks from the first slot.

In yet another embodiment, a method of a user equipment (UE) in a wireless communication system. The method includes receiving a set of higher layer parameters that include a set of configurations for on-demand SS/PBCH blocks, receiving a first MAC-CE, and identifying, based on the set of configurations, a set of actually transmitted SS/PBCH blocks in a burst. The method further includes identifying a first actually transmitted SS/PBCH block from on the set of actually transmitted SS/PBCH blocks in the burst, identifying, based on the first MAC CE, an indication of an activation of a transmission for the on-demand SS/PBCH blocks, determining, based on the first actually transmitted SS/PBCH block, a first slot corresponding to a beginning of the transmission for the on-demand SS/PBCH blocks, and receiving the on-demand SS/PBCH blocks based on the first slot.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of on-demand SSB transmission indicated by gNB according to embodiments of the present disclosure;

FIG. 7 illustrates a flowchart of UE method for determining a starting time of the on-demand SSB transmission based on an indication/trigger from the gNB according to embodiments of the present disclosure;

FIG. 8 illustrates an example of a determination of the starting time of on-demand SSB transmission according to embodiments of the present disclosure;

FIG. 9 illustrates another example of a determination of the starting time of on-demand SSB transmission according to embodiments of the present disclosure;

FIG. 10 illustrates yet another example of a determination of the starting time of on-demand SSB transmission according to embodiments of the present disclosure;

FIG. 11 illustrates yet another example of a determination of the starting time of on-demand SSB transmission according to embodiments of the present disclosure;

FIG. 12 illustrates a flowchart of UE method for determining a starting time of the on-demand SSB transmission based on an indication/trigger from the gNB according to embodiments of the present disclosure;

FIG. 13 illustrates yet another example of a determination of the starting time of on-demand SSB transmission according to embodiments of the present disclosure;

FIG. 14 illustrates yet another example of a determination of the starting time of on-demand SSB transmission according to embodiments of the present disclosure;

FIG. 15 illustrates yet another example of a determination of the starting time of on-demand SSB transmission according to embodiments of the present disclosure;

FIG. 16 illustrates yet another example of a determination of the starting time of on-demand SSB transmission according to embodiments of the present disclosure; and

FIG. 17 illustrates a flowchart of UE method for receiving PDSCH based on the resource pattern according to embodiments of the present disclosure.

### DETAILED DESCRIPTION

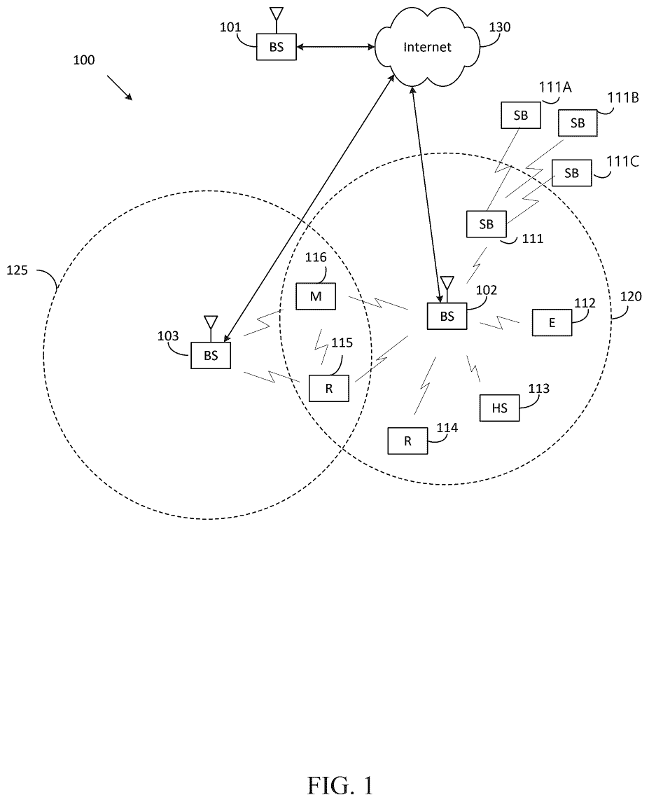

FIGS. 1-17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.1.0, “NR; Physical channels and modulation”; 3GPP TS 38.212 v17.1.0, “NR; Multiplexing and channel coding”; 3GPP TS 38.213 v17.1.0, “NR; Physical layer procedures for control”; 3GPP TS 38.214 v17.1.0, “NR; Physical layer procedures for data”; and 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a determination of a start time for an on-demand transmission in a wireless communication system. In certain embodiments, and one or more of the gNBs 101-103 includes circuitry, programing, or a combination thereof, for supporting an operation for configurations for a determination of a start time for an on-demand transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

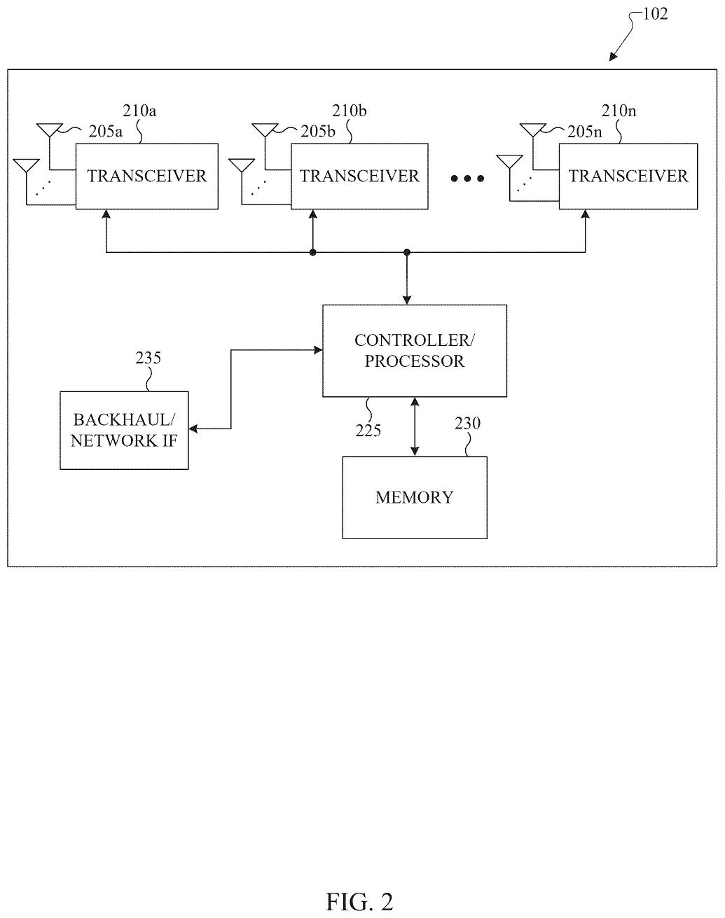

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a determination of a start time for an on-demand transmission in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

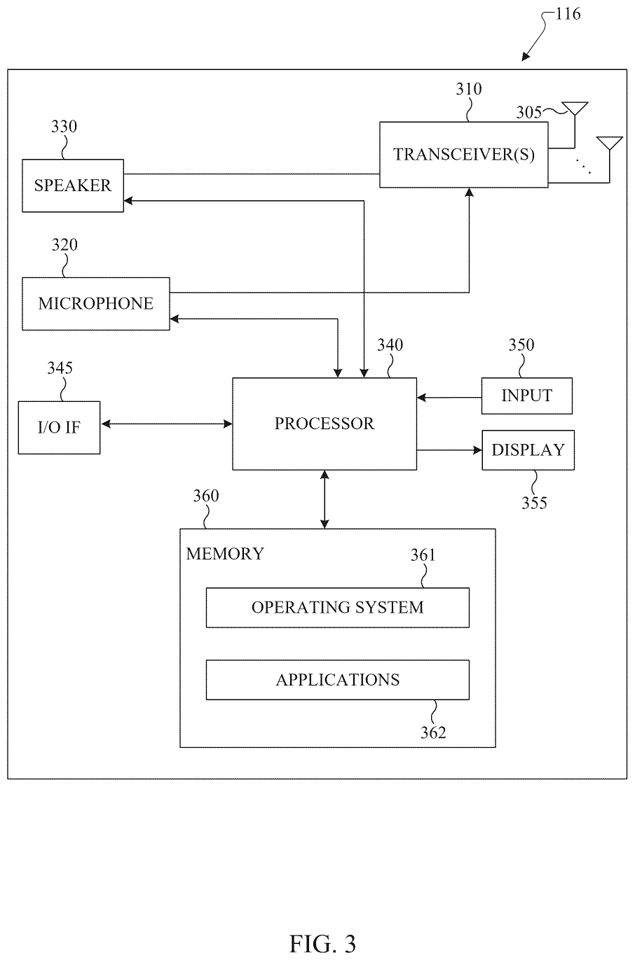

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a determination of a start time for an on-demand transmission in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

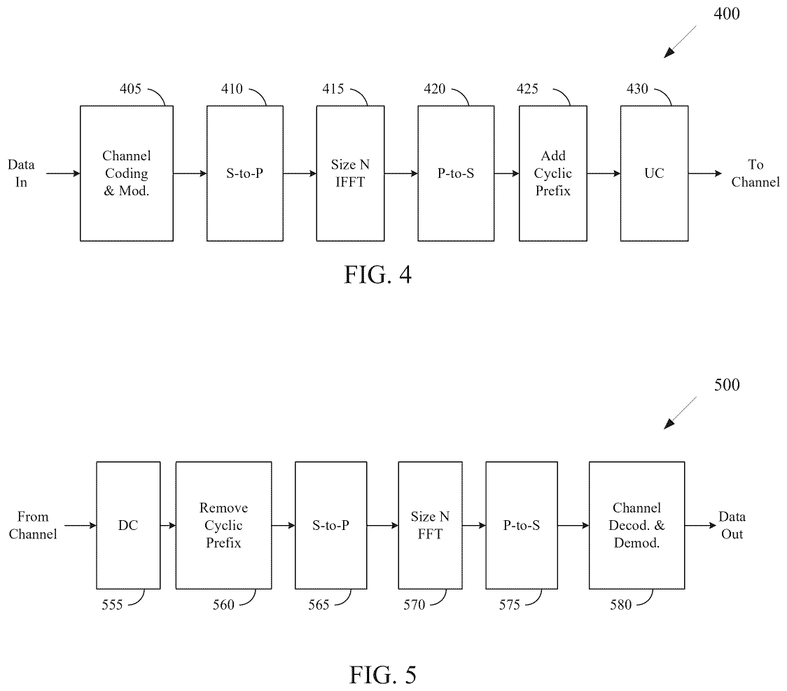

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the transmit path 400 is configured to utilize determined start time for an on-demand transmission in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In NR, for a SCell with periodic SS/PBCH block transmission, a UE can be provided with a configuration for radio resource management (RRM) measurement based on the periodic SS/PBCH block, wherein the configuration can be provided by a RRC parameter. After the RRM measurement, the gNB can provide a configuration of the SCell, e.g., by another RRC parameter. The UE can be further provided with a MAC CE indicating an activation of the SCell, and by using the periodic SS/PBCH blocks on the SCell, or TRS if configured, or the SS/PBCH blocks on another cell (e.g., the PCell) when the SCell is without periodic SS/PBCH block transmission, the UE can get synchronized with the SCell and get ready to transmit or receive on the SCell. After activation of the SCell, if the SCell gets loss of synchronization, the UE can use the periodic SS/PBCH blocks for resynchronization. Since SS/PBCH blocks are transmitted on the SCell periodically, the power consumption for SS/PBCH blocks can be significantly large. To reduce the power consumption, on-demand SSB can be supported on the SCell.

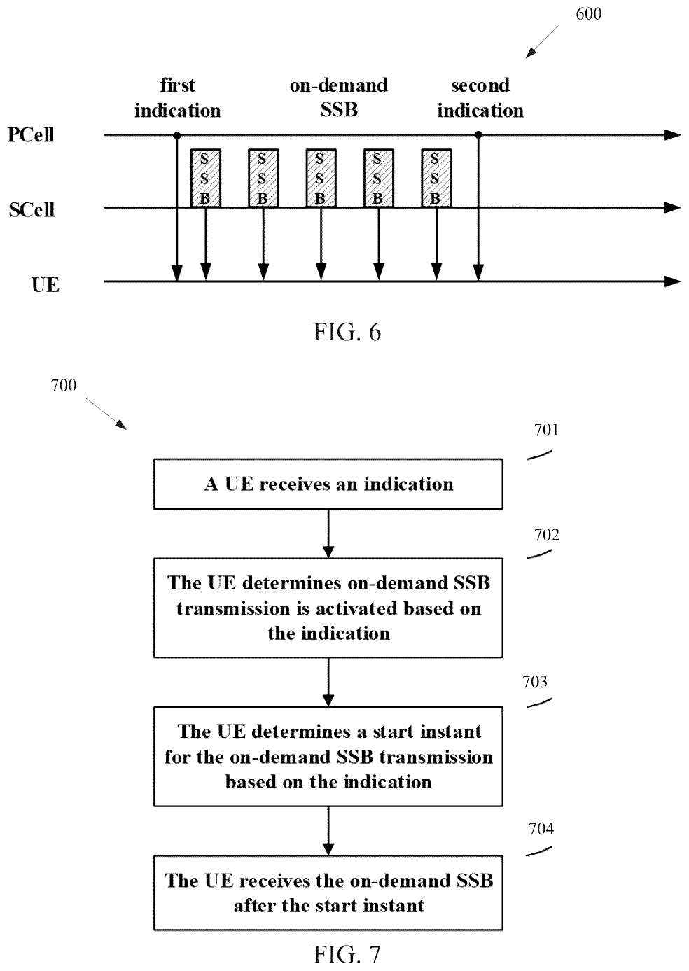

For example, on-demand SSB(s) can be triggered to be transmitted by a first indication (e.g., a first DCI format, a first MAC CE, or a first higher layer parameter) from the gNB and/or triggered to be terminated by a second indication (e.g., a second DCI format, a first MAC CE, or a first higher layer parameter) from the gNB. For some example procedures, the second indication can be absent and the UE assumes the triggered on-demand SSB transmission is not terminated, e.g., periodic manner after triggered, or terminated without an explicit indication. An illustration of the on-demand SSB triggered by gNB is shown FIG. 6.

FIG. 6 illustrates an example of on-demand SSB transmission indicated by gNB 600 according to embodiments of the present disclosure. An embodiment of the on-demand SSB transmission indicated by gNB 600 shown in FIG. 6 is for illustration only.

The present disclosure includes the design details on determining the start of the transmission for the on-demand SSB. The following notations are used in the disclosure, wherein the corresponding component can be fixed, or included in the downlink control information (DCI) format, a MAC CE, or RRC parameters: (i) O: a time domain offset for the on-demand SSB transmission; (ii) I: a time domain interval or periodicity for the on-demand SSB transmission; (iii) N: a time duration (e.g., a number of transmitted SSB bursts) for the on-demand SSB transmission; and (iv) t_proc: a minimum processing time of the indication/trigger and/or preparation for the on-demand SSB transmission.

In one example, when the indication/trigger is a MAC CE, then the timing refers to the minimum processing time of the MAC CE and/or preparation for the on-demand SSB transmission. In one example, when the indication/trigger is a DCI format, then the timing refers to the minimum processing time of the DCI format and/or preparation for the on-demand SSB transmission. In one example, when the indication/trigger is a RRC parameter, then the timing refers to the minimum processing time of the RRC parameter and/or preparation for the on-demand SSB transmission. In one example, t_proc can be same as or no less than the minimum processing time for SCell activation and/or deactivation using a MAC CE, when the indication/trigger is the MAC CE. In one example, t_proc can be same as or no less than the minimum processing time for SCell activation and/or deactivation using a RRC parameter, when the indication/trigger is the RRC parameter.

In one example, the indication/trigger from the gNB can be used for initiating an on-demand SSB transmission, and the UE can determine the starting time of the on-demand SSB transmission based on examples of this disclosure. In one example, the indication/trigger from the gNB can be used for updating or adapting parameters for an on-going on-demand SSB transmission (e.g., the indication/trigger for updating or adapting is after the indication/trigger for initiating), and the UE can determine the starting time of the on-demand SSB transmission using the updated or adapted parameters based on examples of this disclosure.

In one example, before the time instant that the UE determines as the starting time of the on-demand SSB transmission, the UE may not need to perform Layer 1 measurement and/or Layer 3 measurement based on the on-demand SSB.

In another example, before the time instant that the UE determines as the starting time of the on-demand SSB transmission using new parameter(s) provided by the indication/trigger from the gNB, the UE may not need to perform Layer 1 measurement and/or Layer 3 measurement based on the on-demand SSB with the new parameter(s) (e.g., may perform Layer 1 measurement and/or Layer 3 measurement based on the on-demand SSB with the parameter(s) before the updating or adaptation). For one further evaluation, the new parameter(s) can include at least one of a periodicity, an indication of actually transmitted SSB in the burst, or a duration/number of the on-demand SSB bursts.

The present disclosure focuses on determining start time for on-demand SSB transmission, with or without an explicit indication on the time offset for the on-demand SSB transmission. More precisely, the following aspects are included in the present disclosure: (i) determining the starting time without explicit indication of a time offset: (a) using a half frame as a transmission unit; (b) using a slot as a transmission unit; and (c) using a candidate SSB occasion as a transmission unit; and (ii) determining the starting time with explicit indication of a time offset: (a) using a half frame as a transmission unit; (b) using a slot as a transmission unit; and (c) using a candidate SSB occasion as a transmission unit.

In one embodiment, determining the starting time for on-demand SS/PBCH block transmission without explicit indication of a time offset is provided.

In one embodiment, a UE can determine a starting time of the on-demand SSB transmission based on an indication/trigger from the gNB (e.g., activation and/or adaptation of on-demand SSB transmission, wherein the indication/trigger from the gNB can be a DCI format, or a MAC CE, or a higher layer parameter as described in the present disclosure).

FIG. 7 illustrates a flowchart of UE method 700 for determining a starting time of the on-demand SSB transmission based on an indication/trigger from the gNB according to embodiments of the present disclosure. The UE method 700 as may be performed by a UE (e.g., 111-116 as illustrated in FIG. 1). An embodiment of the UE method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, in step 701, a UE receives an indication. Subsequently, the UE in step 702 determines that an on-demand SSB transmission is activated based on the indication. In step 703, the UE determines a start instant for the on-demand SSB transmission based on the indication. Subsequently, the UE in step 704 receives the on-demand SSB based on the start instant. In one embodiment, a half frame is provided as a transmission unit.

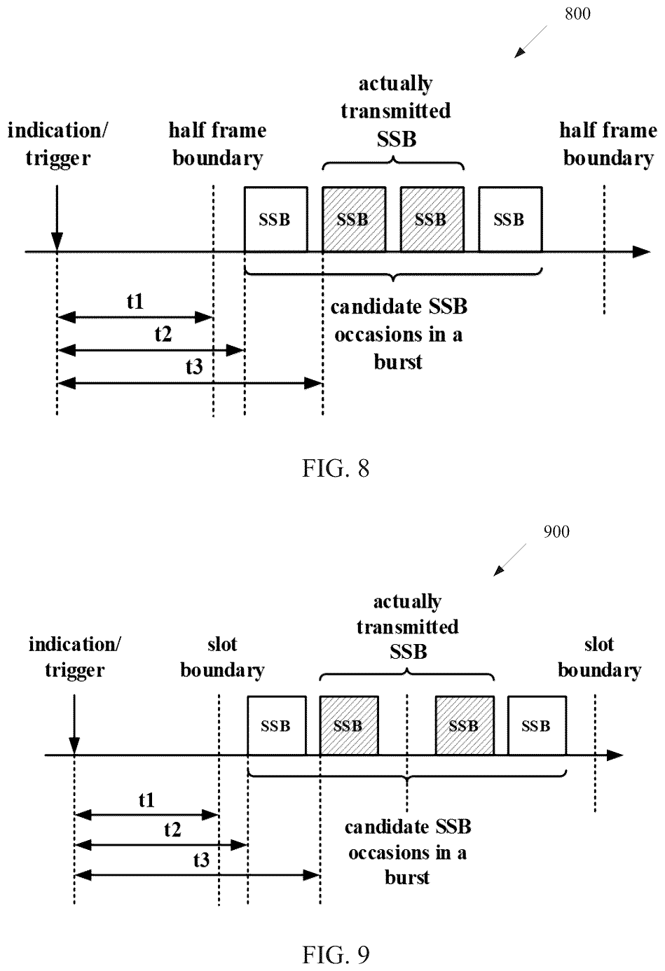

In one example, a UE can assume the on-demand SSB can start to transmit (e.g., assumed to be received by the UE) in the candidate SSB occasions within a half frame, wherein the start of the half frame (e.g., the first slot of the half frame) for on-demand SSB transmission is the first half frame boundary (e.g., the first slot of the half frame) after receiving the indication/trigger from the gNB subject to at least one of the following examples/embodiments. An illustration of the example is shown in FIG. 8.

FIG. 8 illustrates an example of a determination of the starting time of on-demand SSB transmission 800 according to embodiments of the present disclosure. An embodiment of the determination of the starting time of on-demand SSB transmission 800 shown in FIG. 8 is for illustration only.

In one example, the on-demand SSB transmission can be still subject to an indication of actually transmitted SSB within the burst (e.g., further within the half frame), such that a subset of the candidate SSB occasions in the burst are used for actual transmission (e.g., ssb-PositionsInBurst or od-ssb-PositionsInBurst). In one example, the indication of actually transmitted SSB within the burst can be applicable to the candidate SSB occasions in the burst. In one example, the indication of actually transmitted SSB within the burst can be provided by at least one bitmap. In one example, the indication of actually transmitted SSB within the burst can be configured by the gNB using RRC parameter, or indicated by the gNB using a MAC CE or DCI format.

In one example, the half frame can be determined based on further necessary information or operations that the duration from the reception of the indication/trigger from the gNB (e.g., (the start or end of the) slot(s) including the indication/trigger from the gNB) to the start of the half frame (e.g., t1 as illustrated in FIG. 8) can be larger than or no less than a threshold (e.g., t_proc for minimum processing time of the indication/trigger and/or preparation for the on-demand SSB transmission).

In another example, the half frame can be determined based on further necessary information or operations that the duration from the reception of the indication/trigger from the gNB (e.g., the end of the slot(s) including the indication/trigger from the gNB) to the start of the first candidate SSB occasions in the half frame (e.g., t2 as illustrated in FIG. 8) can be larger than or no less than a threshold (e.g., t_proc for minimum processing time of the indication/trigger and/or preparation for the on-demand SSB transmission).

In yet another example, the half frame can be determined based on further necessary information or operations that the duration from the reception of the indication/trigger from the gNB (e.g., the end of the slot(s) including the indication/trigger from the gNB) to the start of the slot including the first actually transmitted SSB in the half frame (e.g., t3 as illustrated in FIG. 8) can be larger than or no less than a threshold (e.g., t_proc for minimum processing time of the indication/trigger and/or preparation for the on-demand SSB transmission). For this example, the UE assumes the on-demand SSB starts to be transmitted from the slot including the first actually transmitted SSB in the half frame.

In yet another example, the half frame can be determined based on further necessary information or operations that the duration from the reception of the indication/trigger from the gNB (e.g., the end of the slot(s) including the indication/trigger from the gNB) to the start of the slot including the (first) candidate SSB corresponding to the first actually transmitted SSB in the half frame (e.g., t3 as illustrated in FIG. 8) can be larger than or no less than a threshold (e.g., t_proc for minimum processing time of the indication/trigger and/or preparation for the on-demand SSB transmission). For this example, the UE assumes the on-demand SSB starts to be transmitted from the slot including the (first) candidate SSB corresponding to the first actually transmitted SSB in the half frame.

In yet another example, the half frame can be determined based on further necessary information or operations that the start of the on-demand SSB transmission is after receiving the SCell activation signaling (e.g., a higher layer parameter, or a MAC CE, or a DCI format indicating the SCell is to be activated).

In yet another example, the half frame can be determined based on further necessary information or operations that the start of the half frame is after the reception of the indication/trigger from the gNB (e.g., the end of the slot(s) including the indication/trigger from the gNB).

In yet another example, the half frame can be determined as the first half frame from a set of half frames, wherein the first half frame includes the slot as the starting slot of on-demand SSB subject to examples, instances, and/or embodiments of the present disclosure, and the set of half frames are configured (e.g., by RRC parameter) or indicated (e.g., by MAC CE or DCI format) by the gNB using a periodicity, a frame offset within the periodicity, and a half frame index within the frame. In one example, the set of half frames are located in frames with SFN given by (SFN mod P)=O, wherein P is the periodicity, and O is the frame offset within the periodicity, and the set of half frames have a half frame index configured or indicated by the gNB.

In one example, the UE can assume the on-demand SSB starts to be transmitted from a half frame (e.g., the first slot of the half frame), wherein the half frame is the (first) half frame (e.g., after the slot (or the ending slot of the slots) including the indication/trigger from the gNB) within a set of half frames, and/or the first slot in the half frame is at least or no less than T_proc with respect to the slot (or the ending slot of the slots) including the indication/trigger from the gNB), where the set of half frames are determined by a periodicity, a frame offset within the periodicity, and a half frame index within the frame configured/indicated by the gNB. For one further evaluation, this example can be applicable when the indication/trigger from the gNB is a RRC parameter, and the corresponding T_proc is the minimum processing time of the RRC parameter and/or preparation for the on-demand SSB transmission.

In one embodiment, a slot is provided as a transmission unit.

In one example, a UE can assume the on-demand SSB can start to transmit (e.g., assumed to be received by the UE) in the candidate SSB occasions within a half frame, wherein the start of the slot(s) including the candidate SSB occasions for on-demand SSB transmission is the first slot after receiving the indication/trigger from the gNB subject to at least one of the following examples and embodiments. An illustration of the example is shown in FIG. 9.

FIG. 9 illustrates another example of a determination of the starting time of on-demand SSB transmission 900 according to embodiments of the present disclosure. An embodiment of the determination of the starting time of on-demand SSB transmission 900 shown in FIG. 9 is for illustration only.

In one example, the on-demand SSB transmission can be still subject to an indication of actually transmitted SSB within the burst (e.g., further within the half frame), such that a subset of the candidate SSB occasions in the burst are used for actual transmission (e.g., ssb-PositionsInBurst or od-ssb-PositionsInBurst). In one example, the indication of actually transmitted SSB within the burst can be applicable to the candidate SSB occasions in the burst. In one example, the indication of actually transmitted SSB within the burst can be provided by at least one bitmap. In one example, the indication of actually transmitted SSB within the burst can be configured by the gNB using RRC parameter, or indicated by the gNB using a MAC CE or DCI format.

In another example, the slot can be determined based on further necessary information or operations that the duration from the reception of the indication/trigger from the gNB (e.g., the (end or start of) the slot(s) including the indication/trigger from the gNB) to (the start of) the slot (e.g., t1 as illustrated in FIG. 9) can be larger than or no less than a threshold (e.g., t_proc for minimum processing time of the indication/trigger and/or preparation for the on-demand SSB transmission).

In yet another example, the slot can be determined based on further necessary information or operations that the duration from the reception of the indication/trigger from the gNB (e.g., the (end or start of) the slot(s) including the indication/trigger from the gNB) to (the start of) the first candidate SSB occasions (e.g., t2 as illustrated in FIG. 9) can be larger than or no less than a threshold (e.g., t_proc for minimum processing time of the indication/trigger and/or preparation for the on-demand SSB transmission).

In yet another example, the slot can be determined based on further necessary information or operations that it is the slot including the first candidate SSB occasion within a burst, e.g., the UE assumes the gNB transmits from the first candidate SSB occasion within a burst, and/or the slot includes the (first) candidate SSB corresponding to the first candidate SSB index in the burst (e.g., index 0).

In yet another example, the slot can be determined based on further necessary information or operations that the duration from the reception of the indication/trigger from the gNB (e.g., (the start or end of) the slot(s) including the indication/trigger from the gNB) to (the start of) the first actually transmitted SSB in the half frame (e.g., t3 as illustrated in FIG. 9) can be larger than or no less than a threshold (e.g., t_proc for minimum processing time of the indication/trigger and/or preparation for the on-demand SSB transmission).

In yet another example, the slot can be determined based on further necessary information and operations that it is the slot including the (first) (candidate) SSB occasion corresponding to the first actually transmitted SSB in the burst, e.g., the UE assumes the gNB transmits from the first actually transmitted SSB within a burst, and/or the slot includes the (first) (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst).

In yet another example, the slot can be determined based on further necessary information and operations that the start of the on-demand SSB transmission is after receiving the SCell activation signaling (e.g., a higher layer parameter, or a MAC CE, or a DCI format indicating the SCell is to be activated).

In yet another example, the half frame can be determined based on further necessary information and operations that the start of the half frame is after the reception of the indication/trigger from the gNB (e.g., the end of the slot(s) including the indication/trigger from the gNB).

In yet another example, the half frame can be determined as the first half frame from a set of half frames, wherein the first half frame includes the slot as the starting slot of on-demand SSB subject to examples, embodiments, and/or instances of this disclosure, and the set of half frames are configured (e.g., by RRC parameter) or indicated (e.g., by MAC CE or DCI format) by the gNB using a periodicity, a frame offset within the periodicity, and a half frame index within the frame. In one example, the set of half frames are located in frames with SFN given by (SFN mod P)=O, wherein P is the periodicity, and O is the frame offset within the periodicity, and the set of half frames have a half frame index configured or indicated by the gNB.

In one example, the UE can assume the on-demand SSB starts to be transmitted from a slot in a half frame, wherein the slot is the first slot including the (first) candidate SSB occasion corresponding to the first actually transmitted SSB in the burst (e.g., ssb-PositionsInBurst or od-ssb-PositionsInBurst) which is at least or no less than T_proc with respect to the slot (or the ending slot of the slots) including the indication/trigger from the gNB, and/or the half frame is the (first) half frame (e.g., after the slot (or the ending slot of the slots) including the indication/trigger from the gNB) within a set of half frames including such slot (e.g., such that the slot corresponding to the start of on-demand SSB transmission satisfies 1) including the (first) candidate SSB occasion corresponding to the first actually transmitted SSB in the burst and 2) being at least or no less than T_proc with respect to the slot (or the ending slot of the slots) including the indication/trigger from the gNB) where the set of half frames are determined by a periodicity, a frame offset within the periodicity, and a half frame index within the frame configured/indicated by the gNB. For one further evaluation, this example can be applicable when the indication/trigger from the gNB is a MAC CE, and the corresponding T_proc is the minimum processing time of the MAC CE and/or preparation for the on-demand SSB transmission.

In one embodiment, an SSB occasion is provided as a transmission unit.

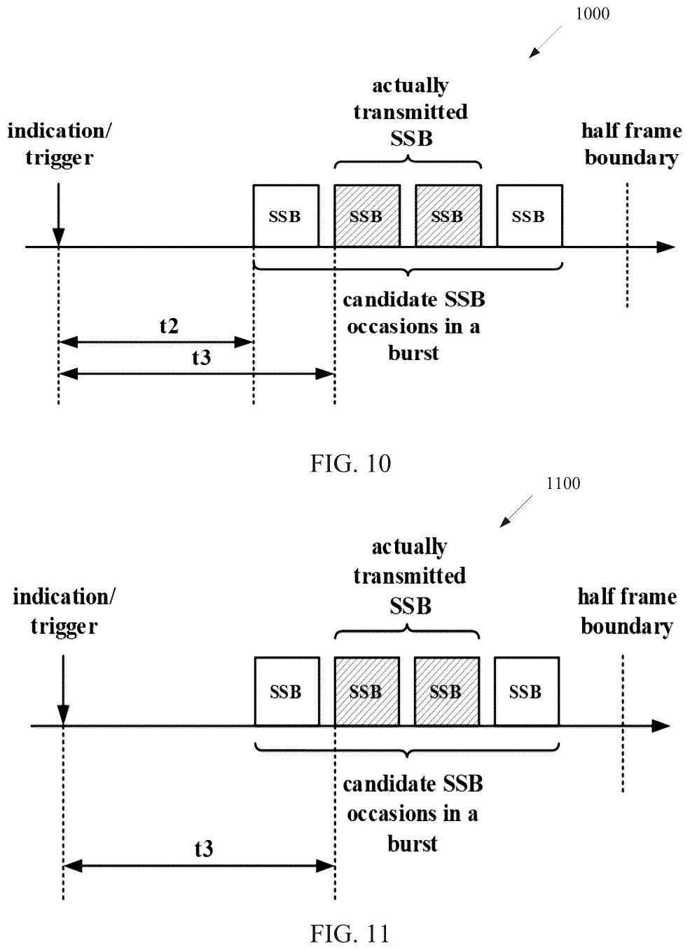

In one example, a UE can assume the on-demand SSB can start to transmit (e.g., assumed to be received by the UE) in the candidate SSB occasions, wherein the start of the candidate SSB occasion is after the indication/trigger from the gNB subject to at least one of the following example, embodiments, and/or instances. An illustration of the example is shown in FIG. 10.

FIG. 10 illustrates yet another example of a determination of the starting time of on-demand SSB transmission 1000 according to embodiments of the present disclosure. An embodiment of the determination of the starting time of on-demand SSB transmission 1000 shown in FIG. 10 is for illustration only.

In one example, the on-demand SSB transmission can be still subject to an indication of actually transmitted SSB within the burst (e.g., further within the half frame), such that a subset of the candidate SSB occasions in the burst are used for actual transmission. In one example, the indication of actually transmitted SSB within the burst can be applicable to the candidate SSB occasions in the burst. In one example, the indication of actually transmitted SSB within the burst can be provided by at least one bitmap.

In another example, the candidate SSB occasion can be determined based on further necessary information and operations that the duration from the reception of the indication/trigger from the gNB (e.g., the end of the slot(s) including the indication/trigger from the gNB) to the start of the candidate SSB occasion for transmitting on-demand SSB (e.g., t2 as illustrated in FIG. 10) can be larger than or no less than a threshold (e.g., t_proc for minimum processing time of the indication/trigger and/or preparation for the on-demand SSB transmission).

In yet another example, the candidate SSB occasion can be determined based on further necessary information and operations that it is the first candidate SSB occasion within a burst, e.g., the UE assumes the gNB transmits from the first candidate SSB occasion within a burst, and/or the candidate SSB corresponding to the first candidate SSB index in the burst (e.g., index 0).

In yet another example, the candidate SSB occasions can be determined based on further necessary information and operations that the duration from the reception of the indication/trigger from the gNB (e.g., the end of the slot(s) including the indication/trigger from the gNB) to the start of the first actually transmitted SSB in the half frame (e.g., t3 as illustrated in FIG. 10) can be larger than or no less than a threshold (e.g., t_proc for minimum processing time of the indication/trigger and/or preparation for the on-demand SSB transmission).

In yet another example, the candidate SSB occasion can be determined based on further necessary information and operations that it is the first candidate SSB occasion within a burst corresponding to the actually transmitted SSB in the burst, e.g., the UE assumes the gNB transmits from the first actually transmitted SSB within a burst, and/or the (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst).

In yet another example, the candidate SSB occasion can be determined based on further necessary information and operations that the start of the on-demand SSB transmission is after receiving the SCell activation signaling (e.g., a higher layer parameter, or a MAC CE, or a DCI format indicating the SCell is to be activated).

In one example, a UE can assume the on-demand SSB can start to transmit (e.g., assumed to be received by the UE) in the candidate SSB occasions, wherein the start of the candidate SSB occasion corresponding to the actually transmitted SSB is after receiving the indication/trigger from the gNB subject to at least one of the following examples, embodiments, and/or instances. An illustration of the example is shown in FIG. 11.

FIG. 11 illustrates yet another example of a determination of the starting time of on-demand SSB transmission 1100 according to embodiments of the present disclosure. An embodiment of the determination of the starting time of on-demand SSB transmission 1100 shown in FIG. 11 is for illustration only.

In one example, the on-demand SSB transmission can be still subject to an indication of actually transmitted SSB within the burst (e.g., further within the half frame), such that a subset of the candidate SSB occasions in the burst are used for actual transmission. In one example, the indication of actually transmitted SSB within the burst can be applicable to the candidate SSB occasions in the burst. In one example, the indication of actually transmitted SSB within the burst can be provided by at least one bitmap.

In another example, the candidate SSB occasions can be determined based on further necessary information and operations that the duration from the reception of the indication/trigger from the gNB (e.g., the end of the slot(s) including the indication/trigger from the gNB) to the start of the first actually transmitted SSB in the half frame (e.g., t3 as illustrated in FIG. 11) can be larger than or no less than a threshold (e.g., t_proc for minimum processing time of the indication/trigger and/or preparation for the on-demand SSB transmission).

In yet another example, the candidate SSB occasion can be determined based on further necessary information and operations that it is the first candidate SSB occasion within a burst corresponding to the actually transmitted SSB in the burst, e.g., the UE assumes the gNB transmits from the first actually transmitted SSB within a burst, and/or the (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst).

In yet another example, the candidate SSB occasion can be determined based on further necessary information and operations that the start of the on-demand SSB transmission is after receiving the SCell activation signaling (e.g., a higher layer parameter, or a MAC CE, or a DCI format indicating the SCell is to be activated).

In one embodiment, determining the starting time with explicit indication of time offset is provided.

In one embodiment, a UE can determine the starting time of the on-demand SSB transmission based on an indication/trigger from the gNB (e.g., activation and/or adaptation of on-demand SSB transmission) and a time offset explicitly provided by the gNB (e.g., denoted by O, which can be provided by at least one of a DCI format, a MAC CE, or a higher layer parameter). The time offset can be provided in the indication/trigger from the gNB, or the time offset can be provided in another indication (e.g., at least one of a DCI format, a MAC CE, or a higher layer parameter) other than the indication/trigger from the gNB.

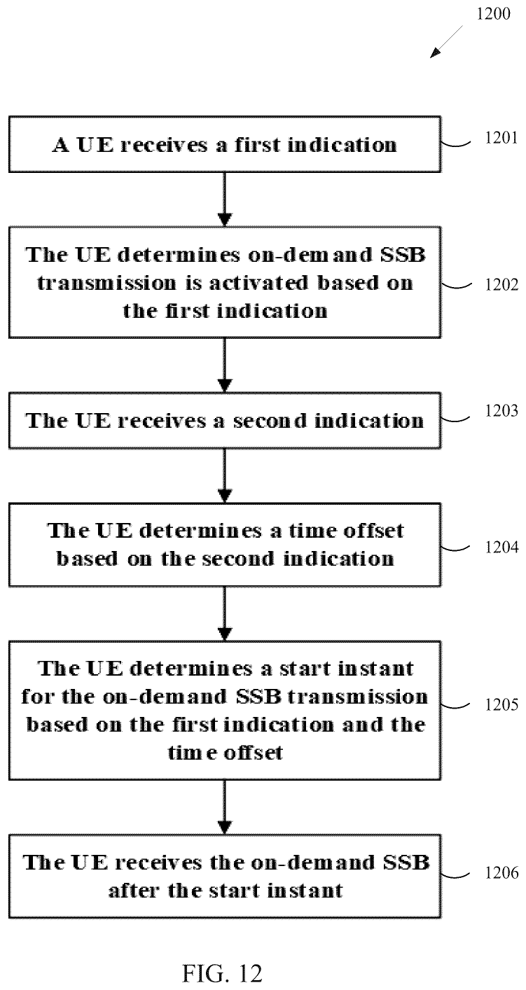

FIG. 12 illustrates a flowchart of UE method 1200 for determining a starting time of the on-demand SSB transmission based on an indication/trigger from the gNB according to embodiments of the present disclosure. The UE method 1200 as may be performed by a UE (e.g., 111-116 as illustrated in FIG. 1). An embodiment of the UE method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, in step 1201, a UE receives a first indication. Subsequently, the UE in step 1202 determines that an on-demand SSB transmission is activated based on the first indication. Subsequently, the UE in step 1203 receives a second indication. Next, the UE in step 1204 determines a time offset based on the second indication. Next, in step 1205, the UE determines a start instant for the on-demand SSB transmission based on the first indication and the time offset. Finally, in step 1206, the UE receives the on-demand SSB after the start instant.

In one embodiment, a half frame is provided as a transmission unit.

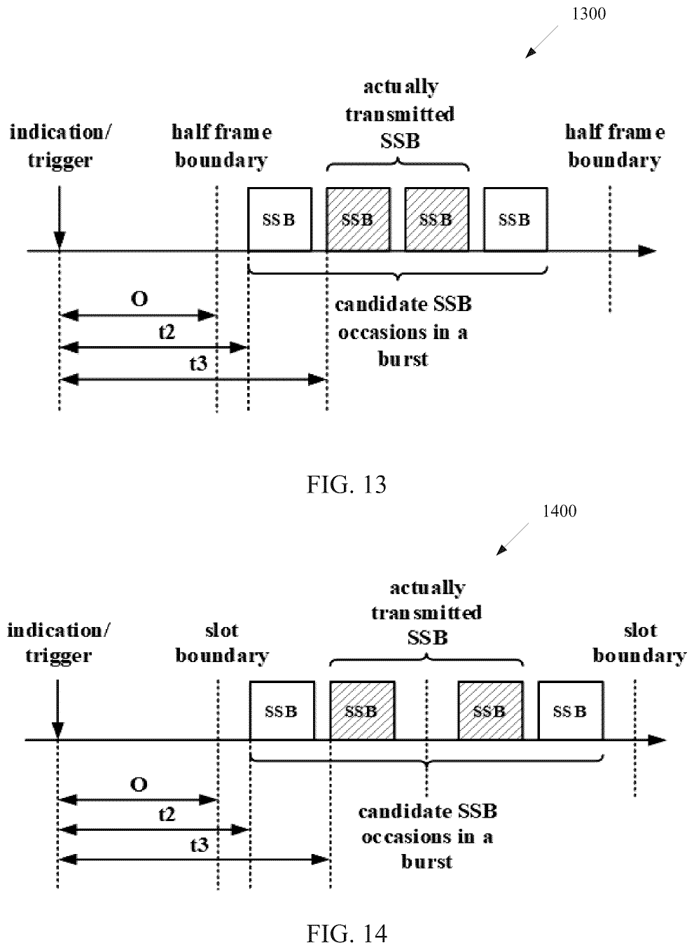

In one example, the unit of O is a half frame (or equivalently a SSB transmission burst, when every SSB transmission burst is within a half frame), and a UE can assume the on-demand SSB can start to transmit (e.g., assumed to be received by the UE) in the candidate SSB occasions within a half frame, wherein the start of the half frame is the first half frame boundary after receiving the indication/trigger from the gNB with a time offset as O, subject to at least one of the following examples, embodiment, and/or instances. An illustration of the example is shown in FIG. 13.

FIG. 13 illustrates yet another example of a determination of the starting time of on-demand SSB transmission 1300 according to embodiments of the present disclosure. An embodiment of the determination of the starting time of on-demand SSB transmission 1300 shown in FIG. 13 is for illustration only.

In one example, the on-demand SSB transmission can be still subject to an indication of actually transmitted SSB within the burst (e.g., further within the half frame), such that a subset of the candidate SSB occasions in the burst are used for actual transmission. In one example, the indication of actually transmitted SSB within the burst can be applicable to the candidate SSB occasions in the burst. In one example, the indication of actually transmitted SSB within the burst can be provided by at least one bitmap.

In another example, if O=0, the UE can assume the start of on-demand SSB transmission is within the same half frame as the reception of the indication/trigger.

In yet another example, if the reception of the indication/trigger is within half frame n_hf, then the start of on-demand SSB transmission is determined as to be within the half frame n_hf+O.

In yet another example, a UE can assume O can be larger than or no less than a threshold (e.g., t_proc for minimum processing time of the indication/trigger and/or preparation for the on-demand SSB transmission).

In yet another example, the half frame can be determined based on further necessary information and operations that the duration from the reception of the indication/trigger from the gNB (e.g., the end of the slot(s) including the indication/trigger from the gNB) to the start of the first candidate SSB occasions in the half frame (e.g., t2 as illustrated in FIG. 13) can be larger than or no less than a threshold (e.g., t_proc for minimum processing time of the indication/trigger and/or preparation for the on-demand SSB transmission).

In yet another example, the first slot of the half frame including the candidate SSB occasion can be determined based on further necessary information and operations that it is the slot including the first candidate SSB occasion within a burst, e.g., the UE assumes the gNB transmits from the first candidate SSB occasion within a burst, and/or the slot includes the (first) candidate SSB corresponding to the first candidate SSB index in the burst (e.g., index 0).

In yet another example, the half frame can be determined based on further necessary information and operations that the duration from the reception of the indication/trigger from the gNB (e.g., the end of the slot(s) including the indication/trigger from the gNB) to the start of the first actually transmitted SSB in the half frame (e.g., t3 as illustrated in FIG. 13) can be larger than or no less than a threshold (e.g., t_proc for minimum processing time of the indication/trigger and/or preparation for the on-demand SSB transmission).

In one embodiment, a slot is provided as a transmission unit.

In one example, the unit of O is a slot, and a UE can assume the on-demand SSB can start to transmit (e.g., assumed to be received by the UE) in the candidate SSB occasions within a half frame, wherein the start of the slot including the first candidate SSB occasion is the one after the slot including the indication/trigger from the gNB with a time offset as O, subject to at least one of the following examples, embodiment, and/or instances. An illustration of the example is shown in FIG. 14.

FIG. 14 illustrates yet another example of a determination of the starting time of on-demand SSB transmission 1400 according to embodiments of the present disclosure. An embodiment of the determination of the starting time of on-demand SSB transmission 1400 shown in FIG. 14 is for illustration only.

In one example, the on-demand SSB transmission can be still subject to an indication of actually transmitted SSB within the burst (e.g., further within the half frame), such that a subset of the candidate SSB occasions in the burst are used for actual transmission. In one example, the indication of actually transmitted SSB within the burst can be applicable to the candidate SSB occasions in the burst. In one example, the indication of actually transmitted SSB within the burst can be provided by at least one bitmap.

In another example, if O=0, the UE can assume the start of on-demand SSB transmission is within the same slot as the reception of the indication/trigger.

In yet another example, if the reception of the indication/trigger is within slot n_sl, then the start of on-demand SSB transmission is determined as to be within the slot n_sl+O.

In yet another example, a UE can assume O can be larger than or no less than a threshold (e.g., t_proc for minimum processing time of the indication/trigger and/or preparation for the on-demand SSB transmission).

In yet another example, the slot can be determined based on further necessary information and operations that the duration from the reception of the indication/trigger from the gNB (e.g., the end of the slot(s) including the indication/trigger from the gNB) to the start of the first candidate SSB occasions in the slot (e.g., t2 as illustrated in FIG. 14) can be larger than or no less than a threshold (e.g., t_proc for minimum processing time of the indication/trigger and/or preparation for the on-demand SSB transmission).

In yet another example, the candidate SSB occasion can be determined based on further necessary information and operations that it is the first candidate SSB occasion within a burst, e.g., the UE assumes the gNB transmits from the first candidate SSB occasion within a burst.

In yet another example, the slot can be determined based on further necessary information and operations that the duration from the reception of the indication/trigger from the gNB (e.g., the end of the slot(s) including the indication/trigger from the gNB) to the start of the first actually transmitted SSB in the slot (e.g., t3 in FIG. 14) can be larger than or no less than a threshold (e.g., t_proc for minimum processing time of the indication/trigger and/or preparation for the on-demand SSB transmission).

In yet another example, the slot including the candidate SSB occasion can be determined based on further necessary information and operations that it is the slot including the first candidate SSB occasion within a burst corresponding to the actually transmitted SSB in the burst, e.g., the UE assumes the gNB transmits from the first actually transmitted SSB within a burst, and/or the slot includes the (first) (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst).

In one embodiment, an SSB occasion or OFDM symbol is provided as a transmission unit.

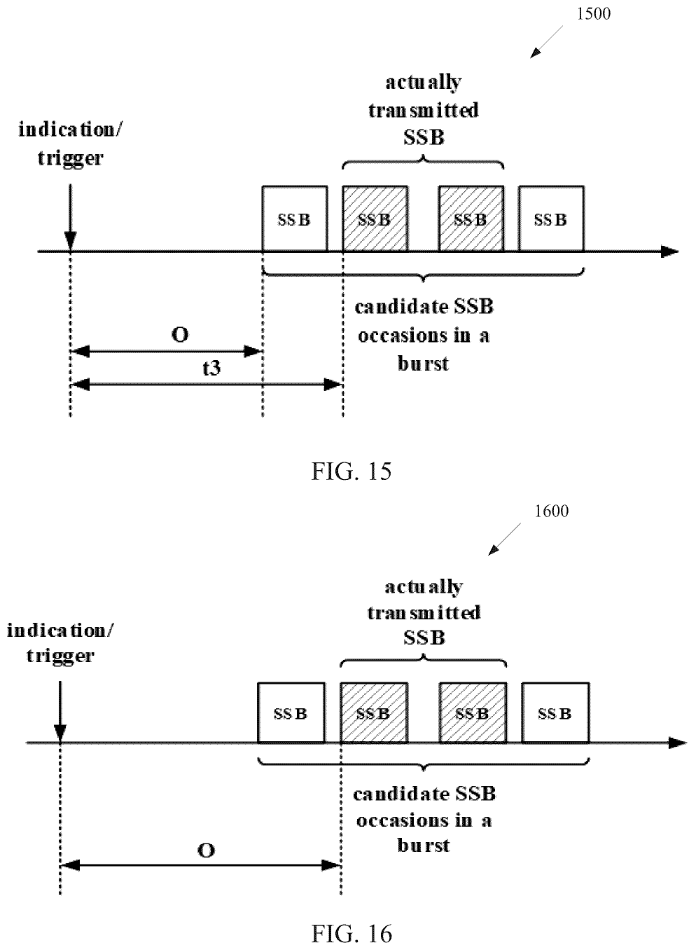

In one example, the unit of O is a candidate SSB occasion or an OFDM symbol, and a UE can assume the on-demand SSB can start to transmit (e.g., assumed to be received by the UE) in the candidate SSB occasions within a half frame, wherein the start of the first candidate SSB occasion is the one after the indication/trigger from the gNB with a time offset as O, subject to at least one of the following example, embodiment, and/or instances. An illustration of the example is shown in FIG. 15.

FIG. 15 illustrates yet another example of a determination of the starting time of on-demand SSB transmission 1500 according to embodiments of the present disclosure. An embodiment of the determination of the starting time of on-demand SSB transmission 1500 shown in FIG. 15 is for illustration only.

In one example, the on-demand SSB transmission can be still subject to an indication of actually transmitted SSB within the burst (e.g., further within the half frame), such that a subset of the candidate SSB occasions in the burst are used for actual transmission. In one example, the indication of actually transmitted SSB within the burst can be applicable to the candidate SSB occasions in the burst. In one example, the indication of actually transmitted SSB within the burst can be provided by at least one bitmap.

In another example, if O=0, the UE can assume the start of on-demand SSB transmission is within the candidate SSB occasion that overlapping with the reception of the indication/trigger.

In yet another example, a UE can assume O can be larger than or no less than a threshold (e.g., t_proc for minimum processing time of the indication/trigger and/or preparation for the on-demand SSB transmission).

In yet another example, the candidate SSB occasion can be determined based on further necessary information and operations that the duration from the reception of the indication/trigger from the gNB (e.g., the end of the slot(s) including the indication/trigger from the gNB) to the start of the first actually transmitted SSB in the slot (e.g., t3 as illustrated in FIG. 15) can be larger than or no less than a threshold (e.g., t_proc for minimum processing time of the indication/trigger and/or preparation for the on-demand SSB transmission).

In yet another example, the candidate SSB occasion can be determined based on further necessary information and operations that it is the first candidate SSB occasion within a burst corresponding to the actually transmitted SSB in the burst, e.g., the UE assumes the gNB transmits from the first actually transmitted SSB within a burst, and/or the (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst).

In one example, the unit of O is a candidate SSB occasion or an OFDM symbol, and a UE can assume the on-demand SSB can start to transmit (e.g., assumed to be received by the UE) in the candidate SSB occasions within a half frame, wherein the start of the first candidate SSB occasion corresponding to the actually transmitted SSB is the one after the indication/trigger from the gNB with a time offset as O, subject to at least one of the following examples, embodiments, and/or instances. An illustration of the example is shown in FIG. 16.

FIG. 16 illustrates yet another example of a determination of the starting time of on-demand SSB transmission 1600 according to embodiments of the present disclosure. An embodiment of the determination of the starting time of on-demand SSB transmission 1600 shown in FIG. 16 is for illustration only.

In one example, the on-demand SSB transmission can be still subject to an indication of actually transmitted SSB within the burst (e.g., further within the half frame), such that a subset of the candidate SSB occasions in the burst are used for actual transmission. In one example, the indication of actually transmitted SSB within the burst can be applicable to the candidate SSB occasions in the burst. In one example, the indication of actually transmitted SSB within the burst can be provided by at least one bitmap.

In another example, if O=0, the UE can assume the start of on-demand SSB transmission is within the candidate SSB occasion that overlapping with the reception of the indication/trigger.

In yet another example, a UE can assume O can be larger than or no less than a threshold (e.g., t_proc for minimum processing time of the indication/trigger and/or preparation for the on-demand SSB transmission).

In yet another example, the candidate SSB occasion can be determined based on further necessary information and operations that it is the first candidate SSB occasion within a burst corresponding to the actually transmitted SSB in the burst, e.g., the UE assumes the gNB transmits from the first actually transmitted SSB within a burst, and/or the (candidate) SSB corresponding to the first actually transmitted SSB index (e.g., the index of the leftmost bit taking a value of 1 in the bitmap for actually transmitted SSB indication, or the index of the first actually transmitted SSB index based on the indication of actually transmitted SSB in the burst).

The present disclosure includes the design details on resource allocation of signal and/or channel based on the on-demand SSB.

The present disclosure focuses on resource pattern for an on-demand SSB and its utilization for resource allocation. More precisely, the following aspects are provided in the present disclosure: (i) resource pattern for on-demand SSB; (a) frequency domain RB information, (b) subcarrier spacing, (c) time domain slot and symbol information, (d) time domain periodicity information; and (e) CORESET; (ii) how to provide the resource pattern; (iii) resource allocation based on the resource pattern: (a) PDSCH resource allocation; (b) PDCCH resource allocation; (c) PRACH resource allocation; (d) PUSCH resource allocation; (e) Symbol format determination; and (f) uplink transmission cancellation; and (iv) a UE procedure.

In one embodiment, a resource pattern for an on-demand SSB is provided.

In one embodiment, at least one resource pattern can be configured to a UE.

In one example, the at least one resource pattern can be provided as a RateMatchPattern or its enhancement with respect to the examples in this disclosure.

In one example, one resource pattern can correspond to time and/or frequency domain resources including one on-demand SSB.

In another example, one resource pattern can correspond to time and/or frequency domain resources including a burst of on-demand SSB(s) (e.g., on-demand SSB(s) in a half frame).

In yet another example, one resource pattern can correspond to time and/or frequency domain resources including two candidate on-demand SSBs in a slot.

In yet another example, one resource pattern can correspond to time and/or frequency domain resources including multiple candidate on-demand SSBs in a burst that share the same time domain occasions in a slot.

In one embodiment, frequency domain RB information is provided.

In one example, the at least one resource pattern can include a frequency domain indication on the resources, wherein the frequency domain indication can be a bitmap indicating the RBs of resources.

In one example, a UE can expect the indicated RBs are contiguous.

In another example, a UE can expect the number of RBs is same as the bandwidth of on-demand SSB, e.g., 12 RBs.

In yet another example, a UE can expect the RBs include the bandwidth of on-demand SSB.

In another example, the at least one resource pattern can include a frequency domain indication on the resources, wherein the frequency domain indication can be an indication of the frequency domain location of the on-demand SSB. For this example, a UE can determine a set of RBs including the on-demand SSB based on the indication.

In one example, the indication can be an indication of the center subcarrier (e.g., subcarrier #60) of the on-demand SSB.

In another example, the indication can be an indication of lowest RB of the on-demand SSB.

In yet another example, the at least one resource pattern can include a frequency domain indication on the resources, wherein the frequency domain indication can be an indication of the starting RB and/or number of RBs.

In one example, the indication can be expressed in a frequency RIV.

In one embodiment, subcarrier spacing is provided.

In one example, the at least one resource pattern can include an indication on the subcarrier of the resources.

In one embodiment, a time domain slot and symbol information are provided.

In one example, the at least one resource pattern can include a time domain indication on the resources, wherein the time domain indication at least includes a bitmap indicating symbols in a number of slots that include the resources.

In one example, the length of the bitmap is the number of symbols in the number of slots.

In one example, the number of slots correspond to a number of slots in a half frame.

In one example, a bitmap indicating symbols in a number of slots that include the resources can be determined without explicit indication/configuration. In one example, the determination can be based on the default SSB mapping in a half frame.

In one example, when the SCS is 15 kHz, the bitmap can be for one slot including the resource, wherein the bitmap for symbols in the one slot can be 00111100111100 and the length of the bitmap is 14.

In one example, when the SCS is 30 kHz, the bitmap can be for two slots including the resource, wherein the bitmap for symbols in the two slots can be 0000111111110000111111110000 and the length of the bitmap is 28.

In one example, when the SCS is 30 kHz, the bitmap can be for one slot including the resource, wherein the bitmap for symbols in the one slot can be 00111100111100 and the length of the bitmap is 14.

In one example, when the SCS is 120 kHz, the bitmap can be for two slots including the resource, wherein the bitmap for symbols in the two slots can be 0000111111110000111111110000 and the length of the bitmap is 28.

In one example, when the SCS is 240 kHz, the bitmap can be for four slots including the resource, wherein the bitmap for symbols in the four slots can be 00000000111111111111111100000000111111111111111100000000 and the length of the bitmap is 56.

In one example, when the SCS is 480 kHz, the bitmap can be for one slot including the resource, wherein the bitmap for symbols in the one slot can be 00111100011110 and the length of the bitmap is 14.

In one example, when the SCS is 960 kHz, the bitmap can be for one slot including the resource, wherein the bitmap for symbols in the one slot can be 00111100011110 and the length of the bitmap is 14.

In one embodiment, time domain periodicity information is provided.

In one example, the at least one resource pattern can include a time domain indication on the resources, wherein the time domain indication at least includes a periodicity or interval for the number of slots or half frame occurring in a periodic manner.

In one example, the periodicity or interval can take value from the set {5, 10, 20, 40, 80, 160} ms or its subset, which can also be expressed in a number of slots subject to the applicable SCS.

In another example, the at least one resource pattern can include a time domain indication on the resources, wherein the time domain indication at least includes a bitmap indicating the number of slots or half frame within a periodicity or interval.

In one example, the pattern can be a bitmap indicating which slots within the periodicity or interval include the configured resource.

In one example, the repetition pattern can be a bitmap indicating which half frame(s) within the periodicity or interval include the configured resource.

In one example, the repetition pattern can be determined per SCS.

In one example, the bitmap indicating the number of slots or half frame within a periodicity or interval can be determined without an explicit indication.

In one example, the bitmap can be determined per SCS.

In one example, when the SCS is 15 kHz, and maximum number of candidate SSB within a half frame is 4, the repetition pattern can be for one slot including the resource, wherein the bitmap for the one slot within the half frame can be 11000 . . . 0 and the length of the bitmap corresponds to the number of slots within a half frame.

In one example, when the SCS is 15 kHz, and maximum number of candidate SSB within a half frame is 8, the repetition pattern can be for one slot including the resource, wherein the bitmap for the one slot within the half frame can be 11110 . . . 0 and the length of the bitmap corresponds to the number of slots within a half frame.

In one example, when the SCS is 30 kHz, and maximum number of candidate SSB within a half frame is 4, the repetition pattern can be for one slot including the resource, wherein the bitmap for the one slot within the half frame can be 11000 . . . 0 and the length of the bitmap corresponds to the number of slots within a half frame.

In one example, when the SCS is 30 kHz, and maximum number of candidate SSB within a half frame is 8, the repetition pattern can be for one slot including the resource, wherein the bitmap for the one slot within the half frame can be 11110 . . . 0 and the length of the bitmap corresponds to the number of slots within a half frame.

In one example, when the SCS is 30 kHz, and maximum number of candidate SSB within a half frame is 4, the repetition pattern can be for two slots including the resource, wherein the bitmap for the two slots within the half frame can be 1000 . . . 0 and the length of the bitmap corresponds to the number of slots within a half frame divided by two.

In one example, when the SCS is 30 kHz, and maximum number of candidate SSB within a half frame is 8, the repetition pattern can be for two slots including the resource, wherein the bitmap for the two slots within the half frame can be 1100 . . . 0 and the length of the bitmap corresponds to the number of slots within a half frame divided by two.

In one example, when the SCS is 120 kHz, and maximum number of candidate SSB within a half frame is 64, the repetition pattern can be for two slots including the resource, wherein the bitmap for the two slots within the half frame can be 1111011101110111000 . . . 0 and the length of the bitmap corresponds to the number of slots within a half frame divided by two.

In one example, when the SCS is 240 kHz, and maximum number of candidate SSB within a half frame is 64, the repetition pattern can be for four slots including the resource, wherein the bitmap for the four slots within the half frame can be 1110111000 . . . 0 and the length of the bitmap corresponds to the number of slots within a half frame divided by four.

In one example, when the SCS is 480 kHz, and maximum number of candidate SSB within a half frame is 64, the repetition pattern can be for one slot including the resource, wherein the bitmap for the one slot within the half frame can be 111 . . . 1110 . . . 0 and the length of the bitmap corresponds to the number of slots within a half frame, wherein the first 32 bits of the bitmap take values of 1.

In one example, when the SCS is 960 kHz, and maximum number of candidate SSB within a half frame is 64, the repetition pattern can be for one slot including the resource, wherein the bitmap for the one slot within the half frame can be 111 . . . 1110 . . . 0 and the length of the bitmap corresponds to the number of slots within a half frame, wherein the first 32 bits of the bitmap take values of 1. In one embodiment, CORESET is provided.

In one example, the at least one resource pattern can include an indication on a CORESET which is associated with the resource pattern. When a UE performs resource allocation (e.g., rate matching), both the CORESET and configured resource pattern are used for determining the resource.

In one embodiment, a method to provide the resource pattern is provided.

In one embodiment, at least part of the parameters for the resource pattern can be provided by the gNB using UE dedicated RRC signaling for a SCell.

In one example, at least part of the parameters (e.g., part of the remaining parameters) for the resource pattern can be provided by a MAC CE.

In one example, at least part of the parameters (e.g., part of the remaining parameters) for the resource pattern can be provided by a DCI format.

In one embodiment, resource allocation based on the resource pattern is provided.

In one embodiment, resource allocation, and/or uplink transmission validation, and/or slot/symbol format determination can be performed based on the at least one resource pattern.

In one embodiment, PDSCH resource allocation is provided.

In one example, when receiving a PDSCH, e.g., the PDSCH is scheduled by PDCCH with CRC scrambled by at least one of C-RNTI, MCS-C-RNTI, CS-RNTI, G-RNTI, G-CS-RNTI, or MCCH-RNTI, or the PDSCH is SPS, the DCI format in the associated PDCCH could provide an indication on whether/which the at least one resource pattern or whether/which on-demand SSB is available for PDSCH resource.

In one example, if the at least one resource pattern could correspond to multiple on-demand SSB(s), the DCI format can indicate which of the multiple on-demand SSB(s) is available or not available for PDSCH resource, e.g., using a bitmap.

In one example, if the at least one resource pattern could correspond to one on-demand SSB(s), the DCI format can indicate whether the one on-demand SSB(s) is available or not available for PDSCH resource.

In one example, the DCI format can provide multiple indications and each of the indication corresponds to one resource pattern.

In one example, if the indication indicates the at least one resource pattern or on-demand SSB(s) is not available for PDSCH resource, and if the PDSCH resource allocation overlaps with PRBs corresponding to the at least one resource pattern or on-demand SSB(s), the UE assumes that the PRBs corresponding to the at least one resource pattern or on-demand SSB(s) are not available for PDSCH resource in the symbols corresponding to the at least one resource pattern or on-demand SSB(s).

In one example, when receiving a PDSCH, e.g., the PDSCH is scheduled by PDCCH with CRC scrambled by at least one of SI-RNTI (and the system information indicator in DCI is set to 1), RA-RNTI, MSGB-RNTI, P-RNTI or TC-RNTI, the DCI format in the associated PDCCH could provide an indication on whether/which the at least one resource pattern or whether/which on-demand SSB is available for PDSCH resource.

In one example, if the at least one resource pattern could correspond to multiple on-demand SSB(s), the DCI format can indicate which of the multiple on-demand SSB(s) is available or not available for PDSCH resource, e.g., using a bitmap.

In one example, if the at least one resource pattern could correspond to one on-demand SSB(s), the DCI format can indicate whether the one on-demand SSB(s) is available or not available for PDSCH resource.

In one example, the DCI format can provide multiple indications and each of the indication corresponds to one resource pattern.

In one example, if the indication indicates the at least one resource pattern or on-demand SSB(s) is not available for PDSCH resource, and if the PDSCH resource allocation overlaps with PRBs corresponding to the at least one resource pattern or on-demand SSB(s), the UE assumes that the PRBs corresponding to the at least one resource pattern or on-demand SSB(s) are not available for PDSCH resource in the symbols corresponding to the at least one resource pattern or on-demand SSB(s).

In one example, when receiving a PDSCH, e.g., the PDSCH is scheduled by PDCCH with CRC scrambled by SI-RNTI (and the system information indicator in DCI is set to 0), the DCI format in the associated PDCCH could provide an indication on whether/which the at least one resource pattern or whether/which on-demand SSB is available for PDSCH resource.

In one example, if the at least one resource pattern could correspond to multiple on-demand SSB(s), the DCI format can indicate which of the multiple on-demand SSB(s) is available or not available for PDSCH resource, e.g., using a bitmap.

In one example, if the at least one resource pattern could correspond to one on-demand SSB(s), the DCI format can indicate whether the one on-demand SSB(s) is available or not available for PDSCH resource.

In one example, the DCI format can provide multiple indications and each of the indication corresponds to one resource pattern.

In one example, if the indication indicates the at least one resource pattern or on-demand SSB(s) is not available for PDSCH resource, and if the PDSCH resource allocation overlaps with PRBs corresponding to the at least one resource pattern or on-demand SSB(s), the UE assumes resources in the resource pattern or on-demand SSB(s) do not overlap with the REs used for a reception of the PDSCH.

In one example, when receiving a PDSCH, e.g., the PDSCH is scheduled by PDCCH with CRC scrambled by at least one of C-RNTI, MCS-C-RNTI, CS-RNTI, G-RNTI, G-CS-RNTI, or MCCH-RNTI, or the PDSCH is SPS, the associated DCI format could provide an indication on which on-demand SSB(s) (e.g., with the same PCI) in the at least one resource pattern are available for PDSCH resource.

In one example, if the indication indicates resources in the resource pattern corresponding to one on-demand SSB is not available for PDSCH resource, and if the PDSCH resource allocation overlaps with PRBs containing the indicated on-demand SS/PBCH block, the UE assumes that the PRBs containing the indicated on-demand SS/PBCH block are not available for PDSCH resource in the symbols where the on-demand SS/PBCH block is transmitted.

In one example, when receiving a PDSCH, e.g., the PDSCH is scheduled by PDCCH with CRC scrambled by at least one of SI-RNTI (and the system information indicator in DCI is set to 1), RA-RNTI, MSGB-RNTI, P-RNTI or TC-RNTI, the associated DCI format could provide an indication on which on-demand SSB(s) in the at least one resource pattern are available for PDSCH resource.

In one example, if the indication indicates resources in the resource pattern corresponding to one on-demand SSB is not available for PDSCH resource, and if the PDSCH resource allocation overlaps with PRBs containing the indicated on-demand SS/PBCH block, the UE assumes that the PRBs containing the indicated on-demand SS/PBCH block are not available for PDSCH resource in the symbols where the on-demand SS/PBCH block is transmitted.

For yet another example, when receiving a PDSCH, e.g., the PDSCH is scheduled by PDCCH with CRC scrambled by SI-RNTI (and the system information indicator in DCI is set to 0), the associated DCI format could provide an indication on which on-demand SSB(s) in the at least one resource pattern are available for PDSCH resource.

In one example, if the indication indicates resources in the resource pattern corresponding to one on-demand SSB is not available for PDSCH resource, the UE assumes the on-demand SSB is not transmitted in the REs used for a reception of the PDSCH.

In one embodiment, PDCCH resource allocation is provided.

In one example, for monitoring a PDCCH candidate by a UE, if at least one RE for a PDCCH candidate overlaps with at least one RE of the at least one resource pattern or on-demand SSB(s) indicated by the at least one resource pattern, the UE may not monitor the PDCCH candidate. In one embodiment, a PRACH validation is provided.

In one example, a PRACH occasion in a PRACH slot is valid if it does not precede resources provided by the at least one resource pattern or on-demand SSB(s) indicated by the at least one resource pattern in the PRACH slot and starts at least N_{gap} symbols after a last symbol of the at least one resource pattern or on-demand SSB(s) indicated by the at least one resource pattern.

In one embodiment, a PUSCH validation is provided.

In one example, a PUSCH occasion in a PUSCH slot is valid if it does not precede resources provided by the at least one resource pattern or on-demand SSB(s) indicated by the at least one resource pattern in the PUSCH slot and starts at least N_{gap} symbols after a last symbol of the at least one resource pattern or on-demand SSB(s) indicated by the at least one resource pattern.

In another example, a repetition of the PUSCH transmission does not include a symbol corresponding to resources in the at least one resource pattern or on-demand SSB(s) indicated by the at least one resource pattern.

In one embodiment, a symbol format determination is provided.

In one example, a UE does not expect a symbol corresponding to the at least one resource pattern or on-demand SSB(s) indicated by the at least one resource pattern to be indicated as uplink by higher layer parameters (e.g., tdd-UL-DL-ConfigurationCommon, or tdd-UL-DL-ConfigurationDedicated).

In one example, a UE does not expect a symbol corresponding to the at least one resource pattern or on-demand SSB(s) indicated by the at least one resource pattern to be indicated as uplink by a DCI format 2_0.

In one embodiment, an uplink transmission cancellation is provided.

In one example, the UE does not transmit PUSCH in a slot, if the transmission may overlap with any symbol corresponding to the at least one resource pattern or on-demand SSB(s) indicated by the at least one resource pattern.

In another example, the UE does not transmit PUCCH in a slot, if the transmission may overlap with any symbol corresponding to the at least one resource pattern or on-demand SSB(s) indicated by the at least one resource pattern.

In yet another example, the UE does not transmit PRACH in a slot, if the transmission may overlap with any symbol corresponding to the at least one resource pattern or on-demand SSB(s) indicated by the at least one resource pattern.

In yet another example, the UE does not transmit SRS in a slot, if the transmission may overlap with any symbol corresponding to the at least one resource pattern or on-demand SSB(s) indicated by the at least one resource pattern.

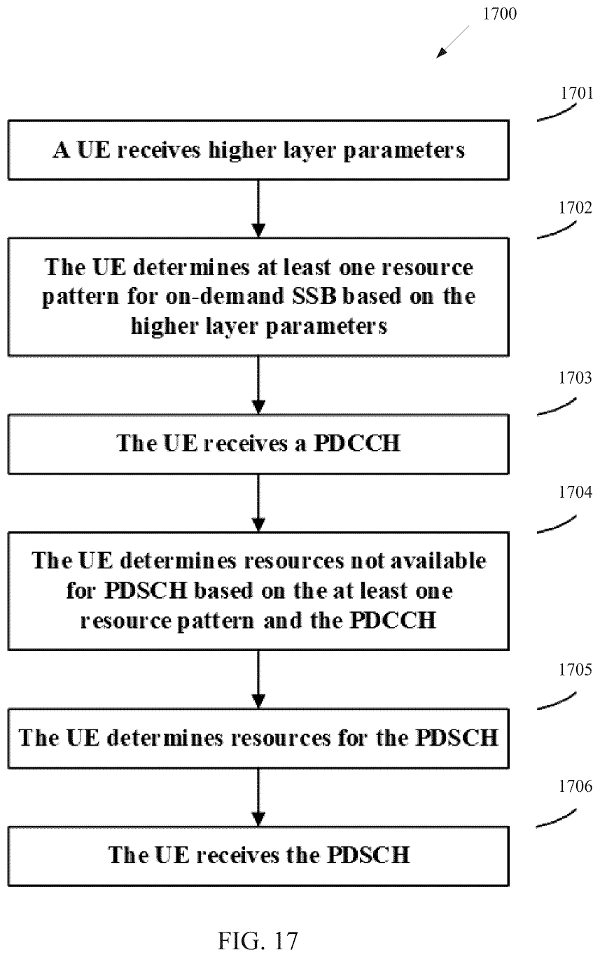

In one embodiment, an example UE procedure for resource allocation based on the configured resource pattern is shown in FIG. 17.

FIG. 17 illustrates a flowchart of UE method 1700 for receiving PDSCH based on the resource pattern according to embodiments of the present disclosure. The UE method 1700 as may be performed by a UE (e.g., 111-116 as illustrated in FIG. 1). An embodiment of the UE method 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

As illustrated in FIG. 17, in step 1701, a UE receives higher layer parameters.

Subsequently, the UE in step 1702 determines at least one resource pattern for an on-demand SSB based on the higher layer parameters. Subsequently, the UE in step 1703 receives a PDCCH. Subsequently, the UE in step 1704 determines resources not available for PDSCH based on the at least one resource pattern and the PDCCH. Next, in step 1705, the UE determines resources for the PDSCH, Finally, in step 1706, the UE receives the PDSCH.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to:
receive a set of higher layer parameters, wherein the set of higher layer parameters include a set of configurations for on-demand synchronization signals and physical broadcast channel (SS/PBCH) blocks; and
receive a first medium access control (MAC) control element (CE); and
a processor operably coupled to the transceiver, the processor configured to:
identify, based on the set of configurations, a set of actually transmitted SS/PBCH blocks in a burst;
identify a first actually transmitted SS/PBCH block from the set of actually transmitted SS/PBCH blocks in the burst;
identify, based on the first MAC CE, an indication of an activation of a transmission for the on-demand SS/PBCH blocks; and
determine, based on the first actually transmitted SS/PBCH block, a first slot corresponding to a beginning of the transmission for the on-demand SS/PBCH blocks,
wherein the transceiver is further configured to receive the on-demand SS/PBCH blocks based on the first slot.

2. The UE of claim 1, wherein:
the first slot includes the first actually transmitted SS/PBCH block in the burst; and
the first slot is after a second slot in which the first MAC CE is received and is no less than a time delay with respect to the second slot.

3. The UE of claim 2, wherein the time delay corresponds to a minimum processing time for the first MAC CE.

4. The UE of claim 1, wherein the processor is further configured to:
identify, based on the set of configurations, a periodicity, a system frame number (SFN) offset for a frame within the periodicity, and a half frame index within the frame; and
determine a set of half frames as candidate half frames for the transmission for the on-demand SS/PBCH blocks.

5. The UE of claim 4, wherein the first slot is determined to be located in a first half frame after a second slot in which the first MAC CE is received and within the set of half frames.

6. The UE of claim 1, wherein:
the transceiver is configured to receive a second MAC CE after the first MAC CE;
the processor is further configured to:
identify, based on the second MAC CE, an indication of an activation of a transmission for the on-demand SS/PBCH blocks with a different periodicity; and
determine a second slot corresponding to a beginning of the transmission for the on-demand SS/PBCH blocks using the different periodicity;
the second slot includes the first actually transmitted SS/PBCH block in the burst; and
the second slot is after a third slot in which the second MAC CE is received and is no less than a time delay with respect to the third slot.

7. The UE of claim 6, wherein:
the processor is further configured to determine, based on the different periodicity, a set of half frames as candidate half frames for the transmission for the on-demand SS/PBCH blocks; and
the second slot is determined to be located in a first half frame after the third slot and within the set of half frames.

8. A base station (BS) in a wireless communication system, the BS comprising:
a processor configured to:
determine a set of higher layer parameters, wherein the set of higher layer parameters include a set of configurations for on-demand synchronization signals and physical broadcast channel (SS/PBCH) blocks;
determine a set of actually transmitted SS/PBCH blocks in a burst in the set of configurations;
identify a first actually transmitted SS/PBCH block from on the set of actually transmitted SS/PBCH blocks in the burst; and
determine, based on the first actually transmitted SS/PBCH block, a first slot corresponding to a beginning of a transmission for the on-demand SS/PBCH blocks; and
a transceiver operably coupled to the processor, the transceiver configured to:
transmit the set of higher layer parameters;
transmit a first medium access control (MAC) control element (CE), the MAC CE including an indication of an activation of the transmission for the on-demand SS/PBCH blocks; and
transmit the on-demand SS/PBCH blocks from the first slot.

9. The BS of claim 8, wherein:
the first slot includes the first actually transmitted SS/PBCH block in the burst; and
the first slot is after a second slot in which the first MAC CE is transmitted and is no less than a time delay with respect to the second slot.

10. The BS of claim 9, wherein the time delay corresponds to a minimum processing time for the first MAC CE.

11. The BS of claim 8, wherein the processor is further configured to:
determine, in the set of configurations, a periodicity, a system frame number (SFN) offset for a frame within the periodicity, and a half frame index within the frame; and
determine a set of half frames as candidate half frames for the transmission for on-demand SS/PBCH blocks.

12. The BS of claim 11, wherein the first slot is determined to be located in a first half frame after a second slot in which the first MAC CE is transmitted and within the set of half frames.

13. The BS of claim 8, wherein:
the processor is further configured to determine a second slot corresponding to a beginning of the transmission for the on-demand SS/PBCH blocks using a different periodicity;
the second slot includes the first actually transmitted SS/PBCH block in the burst;
the second slot is after a third slot in which a second MAC CE is transmitted and is no less than a time delay with respect to the third slot; and
the transceiver is configured to transmit the second MAC CE after the first MAC CE, the second MAC CE including an indication of an activation of a transmission for the on-demand SS/PBCH blocks with the different periodicity.

14. The BS of claim 13, wherein:
the processor is further configured to determine, based on the different periodicity, a set of half frames as candidate half frames for the transmission for the on-demand SS/PBCH blocks; and
the second slot is determined to be located in a first half frame after the third slot and within the set of half frames.

15. A method of a user equipment (UE) in a wireless communication system, the method comprising:
receiving a set of higher layer parameters, wherein the set of higher layer parameters include a set of configurations for on-demand synchronization signals and physical broadcast channel (SS/PBCH) blocks;
receiving a first medium access control (MAC) control element (CE);
identifying, based on the set of configurations, a set of actually transmitted SS/PBCH blocks in a burst;
identifying a first actually transmitted SS/PBCH block from on the set of actually transmitted SS/PBCH blocks in the burst;
identifying, based on the first MAC CE, an indication of an activation of a transmission for the on-demand SS/PBCH blocks;
determining, based on the first actually transmitted SS/PBCH block, a first slot corresponding to a beginning of the transmission for the on-demand SS/PBCH blocks; and
receiving the on-demand SS/PBCH blocks based on the first slot.

16. The method of claim 15, wherein:
the first slot includes the first actually transmitted SS/PBCH block in the burst; and
the first slot is after a second slot in which the first MAC CE is received and is no less than a time delay with respect to the second slot.

17. The method of claim 16, wherein the time delay corresponds to a minimum processing time for the first MAC CE.

18. The method of claim 15 further comprising:
identifying, based on the set of configurations, a periodicity, a system frame number (SFN) offset for a frame within the periodicity, and a half frame index within the frame;
determining a set of half frames as candidate half frames for the transmission for the on-demand SS/PBCH blocks; and
the first slot is determined to be located in a first half frame after a second slot in which the first MAC CE is received and within the set of half frames.

19. The method of claim 15 further comprising:
receiving a second MAC CE after the first MAC CE;
identifying, based on the second MAC CE, an indication of an activation of a transmission for the on-demand SS/PBCH blocks with a different periodicity; and
determining a second slot corresponding to a beginning of the transmission for the on-demand SS/PBCH blocks using the different periodicity, wherein:
the second slot includes the first actually transmitted SS/PBCH block in the burst; and
the second slot is after a third slot in which the second MAC CE is received and is no less than a time delay with respect to the third slot.

20. The method of claim 19 further comprising:
determining, based on the different periodicity, a set of half frames as candidate half frames for the transmission for the on-demand SS/PBCH blocks; and
the second slot is determined to be located in a first half frame after the third slot and within the set of half frames.
